(19) United States
(12) Patent Application Publication
(10) Pub. No.: US 2009/0076211 A1
(43) Pub. Date: Mar. 19, 2009

(54) COPOLYMER SURFACTANTS

(76) Inventors: Yong Yang, Hillsborough, NJ (US); Robert Sheerin, N. Caldwell, NJ (US); Johanna L. Garcia de Visicaro, Lake Hopatcong, NJ (US)

Correspondence Address: KRAMER LEVIN NAFTALIS & FRANKEL LLP;INTELLECTUAL PROPERTY DEPARTMENT, 1177 AVENUE OF THE AMERICAS, NEW YORK, NY, 10036, US

(21) Appl. No.: 12/177,071

(22) Filed: Jul. 21, 2008

Related U.S. Application Data
(63) Continuation-in-part of application No. 11/319,840, filed on Dec. 28, 2005.
Application No. 11/319,840 is a continuation-in-part of application No. 11/193,191, filed on Aug. 1, 2005, now abandoned.
Application No. 11/193,191 is a continuation-in-part of application No. 10/728,599, filed on Dec. 4, 2003, now Pat. No. 7,402,627.
(60) Provisional application No. 60/496,366, filed on Aug. 18, 2003.

(51) Int. Cl. C08L 31/00; C08F 20/08; C09D 1/00; C09D 119/00; C08F 20/04

(52) U.S. Cl. 524/459; 526/317.1; 524/556; 524/460

(57) ABSTRACT

The present invention relates to hyperbranched copolymers and compositions in which they are incorporated, e.g., colorant compositions, tint bases, and coatings such as latex paint, and methods for making such copolymers and compositions.

This application claims the benefit of U.S. provisional application No. 60/496,366, filed Aug. 18, 2003, U.S. application Ser. No. 10/728,599, filed Dec. 4, 2003, U.S. application Ser. No. 11/193,131, filed Jul. 29, 2005 and U.S. application Ser. No. 11/319,840, filed Dec. 28, 2005, the disclosure of each of which is incorporated by reference herein in its entirety. This application is a continuation-in-part of each of U.S. application Ser. No. 10/728,599, U.S. application Ser. No. 11/193,131 and U.S. application Ser. No. 11/319,840 as aforesaid.

### FIELD OF THE INVENTION

The present invention relates to hyperbranched copolymers suitable for utilization in water-based coatings, and to such coatings along with precursor components thereof comprising one or more of those copolymers, including without limitation: latex (i.e., water-based) paints, films produced from such paints, aqueous dispersions of film-forming polymers including tint bases containing at least one of the film-forming polymers, colorant compositions for combination with a tint base or other aqueous dispersion to form such paints, and methods for making the foregoing.

### BACKGROUND OF THE INVENTION

Preliminarily, inclusion of any information or reference citation herein is not an admission that it constitutes prior art.

Latex paints and other water-based coatings have gained market share, especially (though not solely) in respect of architectural applications among other things because of environmental concerns with solvent-based coatings. This is a consequence of the fact that water-based coatings such as latex paints exhibit desirable characteristics which are environmentally friendly compared to those of solvent-based coatings.

However, there are some properties of conventional water-based coatings like latex paints and films produced from them that are problematic. For instance, in order to achieve suitable pigment dispersion in such coatings, e.g. latex paints, and precursor colorant compositions, it is typical to incorporate a significant amount of one or more surfactants and/or one or more dispersants. These surfactants and dispersants contain hydrophilic as well as hydrophobic segments or portions for wetting the pigment material and dispersing it in the coating's (e.g., latex paint's) aqueous phase. Relatively speaking, the amount of surfactants and/or dispersants in water-based coatings like latex paints, especially in deeper-color and clear-base paints, is disadvantageously high due to the need to tint the coating (especially latex paint) with a substantial amount of colorant(s).

Moreover, the capacity of water-based coatings such as latex paint to exhibit good flow and leveling properties thereby providing a paint film with a smooth finish that is substantially free of brush marks (which is particularly desirable for high gloss paints) can be undercut because of the limitations of various types of thickeners typically utilized in such coatings (especially latex paint) to achieve desirable flow and leveling characteristics, i.e., a favorable rheology. Thickeners, such as cellulose ethers, hydrophobically modified cellulose ethers, alkali soluble or swellable emulsions, and hydrophobically modified alkali soluble or swellable emulsions, can cause flow/leveling characteristics to depart from an optimal level.

In a narrow sense, this particular difficulty can be mitigated through incorporation of associative thickeners such as hydrophobically modified ethylene oxide urethane rheology modifiers (“HEURs”) which impart good flow/leveling characteristics.

However, in respect of the broader picture, HEURs are, notably and disadvantageously, very sensitive to composition. For example, variation in the type or amount of latex, pigment, surfactant, solvent and/or other paint ingredients can have a profound impact on the viscosity of a paint containing a HEUR. And, because they contain many of the aforementioned ingredients, precursor colorant compositions have an especially limiting effect on the use of HEUR's. For example, HEURs can only be used in white paints or in light-color base paints. Deep-color base paints with HEURs are known to have disadvantageous viscosity-instability, especially low-shear viscosity-instability, after they are tinted, i.e., admixed with a colorant composition. Colorant compositions contain organic or inorganic pigments, solvents (which can include water), and a large so-called “conventional” surfactant content (e.g., surfactants other than the copolymer surfactants of the present invention as described hereinafter). Such conventional surfactant(s) in colorant compositions interact with HEURs, resulting in an undesirable break-down of physically cross-linked, three-dimensional networks in water-based coatings such as latex paints, and thereby significantly decrease low-shear viscosity. In the high-shear viscosity range, where the viscosity largely depends on the amount of thickener(s) present in the tint-base or other precursor aqueous polymer dispersion, colorant compositions can also reduce the high-shear viscosity through their dilution effect.

More recently, as described for example in U.S. application Ser. No. 10/728,599 filed Dec. 4, 2003, there has been developed a copolymer surfactant which due to the incorporation of specified hydrophilic and hydrophobic moieties exhibits advantageous viscosity-change mitigation properties. Such copolymer imparts tolerable flow/leveling characteristics when incorporated in an aqueous polymer dispersion or water-based coating (such as a tint-base or latex paint). However, it is nonetheless desirable to improve those characteristics qualitatively for the purpose (among other things) of securing a smooth and attractive finished polymer (e.g., latex paint) film.

Thus, it would be highly advantageous if there were available a copolymer which is able to act as a surfactant and capable of conferring desired rheology properties, including good flow and leveling characteristics, and which is suitable for incorporation in a wide variety of pigments and other typical components of a colorant composition, as well as in aqueous polymer dispersions such as a tint-base, and water-based coatings such as latex paints, especially deep-color base paints.

### OBJECTS OF THE INVENTION

It is an object of the invention to provide a copolymer which acts as a surfactant for pigment dispersion.

It is also an object of the invention to provide a copolymer which acts as a surfactant for dispersion of a wide range of pigments, including deep-color pigments.

It is a another object of the to provide a copolymer capable of conferring advantageous rheology properties on a variety of aqueous polymer dispersions and water-based coatings which it is used to formulate.

It is yet another object of the invention to provide a copolymer capable of conferring advantageous rheology properties on such aforementioned variety of aqueous polymer dispersions and water-based coatings while being compatible with a wide range of pigments, including deep-color pigments.

It is a further object of the invention to provide a copolymer capable of conferring advantageous rheology properties on water-based coatings, especially latex paints, which it is used to formulate.

It is yet a further object of the invention to provide a copolymer is capable of conferring advantageous rheology properties on water-based coatings, especially latex paints, while being compatible with a wide range of pigments, including deep-color pigments.

It is still another object of the invention to provide a copolymer which provides improved flow and leveling for use in water-based coatings, especially latex paints.

It is an additional object of the invention to provide a copolymer which acts as a surfactant in water-based coatings such latex paints and confers good flow and leveling properties with a wide range of pigments, including deep-color pigments.

It is still a further object of the invention to provide methods of making such copolymer, colorant composition, aqueous polymer dispersions, and water-based coatings such as and latex paints.

### SUMMARY OF THE INVENTION

In general, the foregoing and other objects are achieved with the invention as follows:

In one aspect, the invention is in a copolymer which is capable of functioning as a surfactant and/or rheology modifier, and which comprises component units derived from one or more members of the group consisting of acrylic monomers, vinyl monomers and styrenic monomers; component units derived from one or more members of the group consisting of carboxylic acid monomers and anhydride monomers, each of which has an unsaturated bond capable of entering into a polymerization reaction; one or more component units corresponding to a surfactant monomer; component units corresponding to one or more chain transfer agents; and component units corresponding to one or more crosslinking monomers, each of which crosslinking monomers has at least three unsaturated bonds capable of entering into a polymerization reaction, is provided.

Such a copolymer forms a part of: colorant compositions comprising the aforementioned copolymer, water and one or more pigments; aqueous polymer dispersions comprising the aforementioned copolymer, water and a film-forming polymer, such as tint-bases comprising the aforementioned copolymer, water, a film forming polymer and, optionally, a white pigment, off-white pigment or extender pigment; and water-based coatings such as latex paints comprising the aforementioned copolymer, water, a film forming polymer, and one or more pigments.

As used herein, a “polymer” is a compound comprising one or more different component units, each such component unit being a moiety corresponding to a particular monomer. A “copolymer” is a polymer comprising at least two different component units, each of which units corresponds to (and is derived from) a different monomer. Thus, a copolymer comprising component units corresponding to three different monomers (also known as a terpolymer) is included within the term “polymer,” as is a polymer comprising one component unit (also known as a homopolymer).

The term “hyperbranched” refers to the multi-branched structure typifying the new copolymers. That structure has a degree of branching which is the result of the presence in the copolymer of component units corresponding to a crosslinking monomer having at least three unsaturated bonds capable of entering into a polymerization reaction, and the interplay between such units and the chain transfer agent(s) which reacts with propagating branches so as to terminate their growth with the result that new branches form at different sizes provided by the component corresponding to the crosslinking monomer.

Correlatively, the expression “hyperbranched copolymer” means a copolymer with one or more constituent component unit(s) corresponding to a crosslinking monomer having at least three unsaturated bonds capable of entering into a polymerization reaction.

Typically, the hyperbranched copolymers of the invention are soluble in aqueous media of about pH 6.0 or greater, but at less than that do not sorb (e.g., absorb or adsorb) water but rather repel or otherwise have a disaffinity for same. Preferably, hyperbranched copolymers of the invention are soluble in aqueous media at pH about 7.0, or more preferably, at pH about 8.0 or greater, and not sorbed below

In another aspect, the invention is in a method of making a hyperbranched copolymer which comprises polymerizing (1) at least one member selected from the group consisting of acrylic monomers, vinyl monomers or styrenated monomers; (2) at least one member selected from the group consisting of carboxylic acid monomers and anhydride monomers having at least one unsaturated bond capable of entering into a polymerization reaction (3) a surfactant monomer; (4) a chain transfer agent; and (5) a crosslinking monomer having at least three unsaturated bonds capable of entering into a polymerization reaction.

In yet another aspect, the invention is in a colorant composition comprising water, a pigment, and a hyperbranched copolymer as aforesaid, suitable for combination with a tint-base or other aqueous polymer dispersion to form a water-based coating such as a latex paint.

In still another favorable aspect, the invention relates to a method of making a colorant composition, which comprises combining a hyperbranched copolymer of the invention, water and at least one pigment.

In a further aspect the invention is in an aqueous polymer dispersion (e.g., a latex binder or a tint-base) which comprises water, a film-forming polymer, and a hyperbranched copolymer of the invention.

In a still further aspect, the invention is in a method of making such aqueous dispersion, which method comprises combining a hyperbranched copolymer of the invention with water and a film-forming polymer.

In yet a further aspect, the invention is in a water-based coating (e.g. a latex paint) which comprises a colorant composition of the invention and an aqueous polymer dispersion (such as a tint-base).

In an additional aspect, the invention is in a method of making a water-based coating (e.g. a latex paint), which comprises combining a colorant composition as aforesaid with an aforementioned aqueous dispersion (e.g., a tint base).

The hyperbranched copolymers of the invention confer significant advantages when added to or incorporated within colorant compositions, aqueous dispersions (including tint-bases), and water-based coatings (including latex paints).

When incorporated within a colorant composition, the hyperbranched copolymers of the invention provide superior flow and leveling characteristics to aqueous dispersions and water-based coatings formulated with the aforementioned colorant composition, without compromising dispersion of pigment(s) (including deep-color pigments) in aqueous dispersions and water-based coatings, and without compromising the viscosity and gloss of aqueous dispersions and water-based coatings.

Furthermore, hyperbranched copolymers of the invention can be advantageously incorporated into aqueous dispersions and water based coatings to achieve superior flow and leveling characteristics without compromising dispersion of pigment(s) (including deep-color pigments) in aqueous dispersions and water-based coatings, and without compromising the viscosity and gloss of aqueous dispersions and water-based coatings.

Still further, hyperbranched copolymers of the invention can also be advantageously incorporated in coatings, inks, adhesives and cosmetics to provide improved flow and leveling characteristics without compromising dispersion of pigment(s) (including deep-color pigments), where present, and without compromising the viscosity and gloss of the coatings, inks, adhesives and cosmetics.

### BRIEF DESCRIPTION OF THE DRAWINGS

FIG. 1 is a depiction of a hyperbranched copolymer of the present invention.

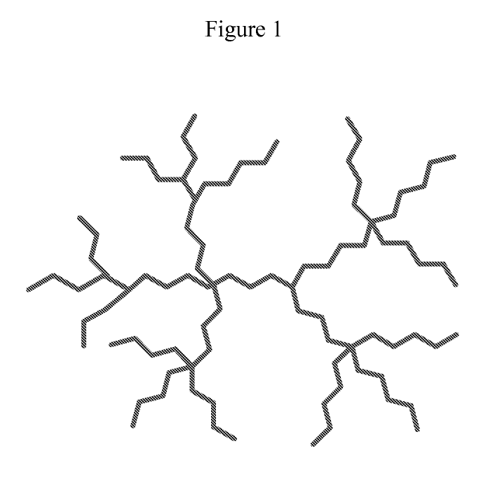

FIG. 2 is a formulaic depiction of chemical structures of various crosslinking monomers useful in forming the copolymers of the present invention.

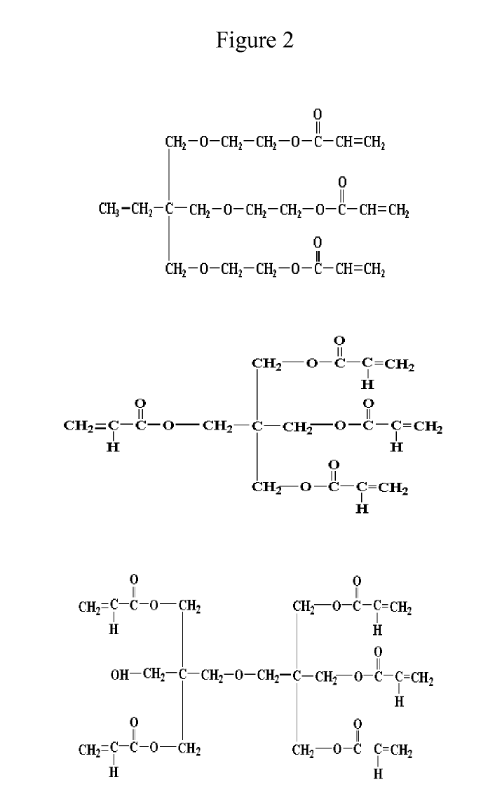

### DETAILED DESCRIPTION OF CERTAIN PREFERRED EMBODIMENTS OF THE INVENTION

The present invention is directed, inter alia, to provision of hyperbranched copolymers capable of functioning as surfactants and/or rheology modifiers. When incorporated in an aqueous polymer dispersion (e.g., a tint-base) or a water-based coating (e.g., a latex paint), these hyperbranched copolymers impart excellent rheological properties, including flow/leveling characteristics, such that superior dried films, including latex paint films are achieved. The hyperbranched copolymers are also suitable for incorporation in colorant compositions, which are precursor components utilized to introduce pigment into—and are not themselves—an aqueous polymer dispersion, such as a tint-base, or ultimately a paint or coating.

A central feature of the invention is the hyperbranched characteristic of the new copolymers in accordance with the invention, and the beneficial effects, imparted by such hyperbranching to the aforementioned compositions (i.e., aqueous polymer dispersions, water based coatings, and colorant compositions) in which such copolymers are incorporated.

By way of overview, in a hyperbranched copolymer of the invention there is: (i) a polymeric chain or backbone formed of one or more acrylic monomers, vinyl monomers, and styrenic monomers and one or more carboxylic acid or anhydride monomers containing an unsaturated bond; (ii) a surfactant monomer having at least one hydrophobic moiety; (iii) a chain transfer agent; and (iv) a crosslinking monomer having at least three unsaturated bonds. Generally speaking, the hydrophobic moiety or moieties found in the component units corresponding to surfactant monomers, e.g., alkyl, alkylphenyl, or tristyrylphenyl groups facilitate the desired association with various types of hydrophobic groups of organic pigments and of other coating ingredients. A single type of surfactant monomer or multiple types of surfactant monomers, and in turn one or more of alkyl, alkylphenyl, or tristyrylphenyl hydrophobic moieties can be present. The hydrophilic moieties found in the component units of the polymer backbone or chain, such as units corresponding to carboxylic acid and/or anhydride monomers as aforesaid, impart solubility to the hyperbranched copolymer in aqueous media, and also facilitate the dispersion of inorganic pigments. Other component units of the copolymer can be used to adjust the balance between hydrophobicity and hydrophilicity.

However, the focus of the present invention is the qualitatively greater degree of branching from the backbone or chain due to the incorporation of component units corresponding to the aforementioned crosslinking monomer and chain transfer agent. Because the crosslinking monomer's unsaturated bonds provide multiple sites for branching propagation, and because there are more unsaturated bonds at which branching can occur, the incidence of branching with the new copolymer is significantly increased. In certain good embodiments of the invention, branching is so profuse that the structure can be accurately described as dendritic.

A significant advantage of the hyperbranched copolymers of the invention is their minimal influence on the flow/leveling properties of a paint or other water-based coating of the invention containing a colorant composition of the invention. In one embodiment, a paint or other water-based coating of the invention has a flow/level rating, measured at 25° C. according to ASTM Standard D4062-99, of at least 6 on a scale of from 1 to 10, with 10 being the best flow/level characteristics. In another embodiment, a paint or other water-based coating of the invention has a flow/level rating, measured in the same way, of about 7. In another embodiment, a paint or other water-based coating of the invention has a flow/level rating, measured in the same way, of about 9. In another embodiment, a paint or other water-based coating of the invention has a flow/level rating, measured in the same way, of 10.

Key parameters are the amount of chain transfer agent, and the amount of crosslinking monomer, utilized in the making of the new copolymer. As will be appreciated, these amounts are correlative. That is to say, the more sites for branching provided by the crosslinking monomer, the larger the potential for more plentiful branching at those more numerous sites. Similarly, the more chain transfer agent present, the lower the molecular weight of the new copolymer, since the branches initiated are terminated by the chain transfer agent. The net effect is that there is an increased number of branching chains (albeit each one possibly being shorter) in comparison with the number of branching chains achieved using conventional surfactants. In the foregoing connection, it is preferred that the amount of chain transfer agent be equal to or greater than about 0.02% by weight, and the amount of crosslinking monomer be at least about 0.5% by weight, so that the desired hyperbranching is achieved. To increase the degree of hyperbranching even further, the respective amounts of chain transfer agent and crosslinking monomer can be correspondingly increased keeping in mind that an avoidance of a substantial excess of either promotes the economics of practicing the invention. In certain preferred embodiments hyperbranched copolymers encompassed within such parameters typically range from about 1,200 Daltons to about 500,000 Daltons in molecular weight, preferably from about 10,000 Daltons to about 200,000 Daltons, and more preferably from about 10,000 Daltons to about 100,000 Daltons.

### Acrylic/Vinyl/Styrenic Component Units

The definitions hereinafter will be useful in understanding the scope of the invention and are applicable to the entire discussion in this specification.

As used herein, “alkyl” shall be deemed to encompass species comprising one or more of a saturated straight chain or branched noncyclic hydrocarbon having from 1 to 30 carbon atoms. Representative saturated straight chain alkyls include -methyl, -ethyl, -n-propyl, -n-butyl, -n-pentyl, -n-hexyl, -n-heptyl, -n-octyl, -n-nonyl, -n-decyl and the like. Representative saturated branched alkyls include -isopropyl, -sec-butyl, -isobutyl, -tert-butyl, -isopentyl, -2-methylbutyl, -3-methylbutyl, -2,2-dimethylbutyl, -2,3-dimethylbutyl, -2-methylpentyl, -3-methylpentyl, -4-methylpentyl, -2-methylhexyl, -3-methylhexyl, -4-methylhexyl, -5-methylhexyl, -2,3-dimethylbutyl, -2,3-dimethylpentyl, -2,4-dimethylpentyl, -2,3-dimethyleyl, -2,4-dimethylhexyl, -2,5-dimethyleyl, -2,2-dimethylpentyl, -2,2-dimethylhexyl, -3,3-dimethylpentyl, -3,3-dimethylhexyl, -4,4-dimethylexyl, -2-ethylpentyl, -3-ethylpentyl, -2-ethylhexyl, -3-ethylhexyl, -4-ethylhexyl, -2-methyl 2-ethylpentyl, -2-methyl-3-ethylpentyl, -2-methyl-4-ethylpentyl, -2-methyl 2-ethylhexyl, -2-methyl-3-ethylhexyl, -2-methyl-4-ethylhexyl, -2,2-diethylpentyl, -3,3-dethylhexyl, -2,2-dethylhexyl, -3,3-dethylhexyl and the like.

As used herein, “alkylphenyl” shall be deemed to encompass species comprising one or more phenyl groups each substituted with at least one alkyl group, where alkyl is as defined above.

As used herein, “styrylphenyl” shall be deemed to encompass species comprising a phenyl group substituted with a styryl group, i.e., a vinyl benzene group where the unsubstituted carbon atom of the vinyl is bonded to the phenyl ring. Thus, in the strictest sense, in a monostyrylphenyl group, one vinyl benzene group is bonded to phenyl; in a distyrylphenyl group, two vinyl benzene groups are bonded to phenyl; and in a tristyrylphenyl group, three vinyl benzene groups are bonded to phenyl. However, it is to be understood that as, e.g., a commercially-available tristyrylphenylpoly(ethyleneoxy) (meth)acrylate (i.e., the compound designated by CAS Reg. Number 174200-85-2) can be a mixture of monostyrylphenylpoly(ethyleneoxy) (meth)acrylate, distyrylphenylpoly(ethyleneoxy) (meth)acrylate and/or tristyrylphenylpoly(ethyleneoxy) (meth)acrylate, as used herein, the term “tristyrylphenyl,” when used either alone or as a portion of a chemical name and unless otherwise indicated, includes monostyrylphenyl, distyrylphenyl, tristyrylphenyl, or a mixture thereof.

### Acrylic Component Units

As mentioned above, component units can correspond to acrylic monomers. Such monomers suitable for use in accordance with the present invention comprise any compounds having acrylic functionality. Preferred acrylic monomers are selected from the group consisting of alkyl acrylates, alkyl methacrylates, acrylate acids and methacrylate acids as well as aromatic derivatives of acrylic and methacrylic acid, acrylamides and acrylonitrile. Typically, the alkyl acrylate and methacrylic monomers (also referred to herein as “alkyl esters of acrylic or methacrylic acid”) will have an alkyl ester portion containing from 1 to about 18, preferably about 1 to 8, carbon atoms per molecule.

Suitable acrylic monomers include, for example, methyl acrylate and methacrylate, ethyl acrylate and methacrylate, butyl acrylate and methacrylate, propyl acrylate and methacrylate, 2-ethyl hexyl acrylate and methacrylate, cyclohexyl acrylate and methacrylate, decyl acrylate and methacrylate, isodecyl acrylate and methacrylate, benzyl acrylate and methacrylate, isobornyl acrylate and methacrylate, neopentyl acrylate and methacrylate, 1-adamantyl methacrylate and various reaction products such as butyl, phenyl, and cresyl glycidyl ethers reacted with acrylic and methacrylic acids, hydroxyl alkyl acrylates and methacrylates such as hydroxyethyl and hydroxypropyl acrylates and methacrylates, amino acrylates, methacrylates as well as acrylic acids such as acrylic and methacrylic acid, ethacrylic acid, alpha-chloroacrylic acid, alpha-cyanoacrylic acid, crotonic acid, beta-acryloxy propionic acid, and beta-styryl acrylic acid.

### Vinyl Component Units

Component units can also correspond to vinyl monomers. Monomers of this type suitable for use in accordance with the present invention include any compounds having vinyl functionality, i.e., ethylenic unsaturation, exclusive of compounds having acrylic functionality, e.g., acrylic acid, methacrylic acid, esters of such acids, acrylonitrile and acrylamides. Preferably, the vinyl monomers are selected from the group consisting of vinyl esters, vinyl aromatic hydrocarbons, vinyl aliphatic hydrocarbons, vinyl alkyl ethers and mixtures thereof.

Suitable vinyl monomers include vinyl esters, such as, for example, vinyl propionate, vinyl laurate, vinyl pivalate, vinyl nonanoate, vinyl decanoate, vinyl neodecanoate, vinyl butyrates, vinyl benzoates, vinyl isopropyl acetates and similar vinyl esters; vinyl aromatic hydrocarbons, such as, for example, styrene, methyl styrenes and similar lower alkyl styrenes, chlorostyrene, vinyl toluene, vinyl naphthalene and divinyl benzene; vinyl aliphatic hydrocarbon monomers, such as, for example, vinyl chloride and vinylidene chloride as well as alpha olefins such as, for example, ethylene, propylene, isobutylene, as well as conjugated dienes such as 1,3-butadiene, methyl-2-butadiene, 1,3-piperylene, 2,3-dimethyl butadiene, isoprene, cyclohexene, cyclopentadiene, and dicyclopentadiene; and vinyl alkyl ethers, such as, for example, methyl vinyl ether, isopropyl vinyl ether, n-butyl vinyl ether, and isobutyl vinyl ether.

Examples of vinyl compounds typically comprising an α,β-ethylenically unsaturated vinyl monomer which contains from 2 to 12 carbon atoms include esters of acrylic and methacrylic acid, such as methyl methacrylate, ethyl acrylate, ethyl methacrylate, 2-ethylhexyl acrylate, butyl acrylate, butyl methacrylate, 2-hydroxyethyl acrylate, 2-hydroxybutyl methacrylate and the like; vinyl esters, such as vinyl acetate, vinyl butyrate, vinyl caprolate and the like; nitrile monomers, such acrylonitrile, methacrylonitrile and the like; vinyl chloride; vinylidene chloride; and the like. In another embodiment, the C₂-C₁₂ α,β-ethylenically unsaturated vinyl monomer is butyl acrylate, ethyl acrylate, ethyl methacrylate, methyl methacrylate, vinyl acetate, acrylonitrile, or a mixture thereof. In another embodiment, the C₂-C₁₂ α,β-ethylenically unsaturated vinyl monomer is butyl acrylate, ethyl methacrylate, methyl methacrylate, vinyl acetate, or a mixture thereof. In another embodiment, the C₂-C₁₂ α,β-ethylenically unsaturated vinyl monomer is butyl acrylate, ethyl methacrylate, vinyl acetate, or a mixture thereof.

### Styrenic Component Units

While theoretically styrene could be characterized as a vinyl, for purposes of this disclosure, suitable moieties which contain a styrenic group are characterized separately from other vinyl species.

That being said, component units corresponding to styrenic monomers are likewise suitable. They include styrenic monomers, such as styrene, vinyltoluene, t-butylstyrene, isopropylstyrene, p-chlorostyrene and the like.

### Specific Components

Further examples of suitable monomers from which are derived component units of the hyperbranched copolymers of the invention include:

vinyl acetate, vinyl propionate, vinyl butyrate, vinyl isobutyrate, vinyl benzoate, vinyl m-chlorobenzoate, vinyl p-methoxybenzoate, vinyl alpha-chloroacetate, vinyl toluene, vinyl chloride, para vinyl benzyl alcohol, etc.

styrene, alpha-methyl styrene, alpha-ethyl styrene, alpha-bromo styrene, 2,6-dichlorostyrene, etc.;

allyl chloride, allyl acetate, allyl benzoate, allyl methacrylate, etc.;

ethylene, acrylonitrile, methacrylonitrile, dimethyl maleate, isopropenyl acetate, isopropenyl isobutyrate, acrylamide, methacrylamide, 1,3-butadiene, etc.;

acrylic acid, methacrylic acid, methyl acrylate, ethyl acrylate, propyl acrylate, isopropyl acrylate, butyl acrylate, isobutyl acrylate, ethylhexyl acrylate, amyl acrylate, 3,5,5-trimethylhexyl acrylate, methyl methacrylate, ethyl methacrylate, propyl methacrylate, dimethylamineothyl methacrylate, isobornyl methacrylate, t-butyl methacrylate, ethyl tiglate, methyl crotonate, ethyl crotonate, 2-hydroxyethyl acrylate, 2-hydroxyethyl methacrylate, 2-hydroxypropyl acrylate, 4-hydroxybutyl methacrylate, 2-hydroxypropyl methacrylate, 3-hydroxybutyl acrylate, 4-hydroxybutyl acrylate, 4 hydroxypypentyl acrylate, 2-hydroxyethyl ethacrylate, 3-hydroxybutyl methacrylate, 2-hydroxyethyl chloroacrylate, diethyleneglycol methacrylate, tetra ethylene glycol acrylate, etc.

In certain good embodiments, the one or more acrylic monomers, vinyl monomers and/or styrenic monomers are present in the polymerization process at a concentration of from about 10% to about 90% by weight, preferably from about 10% to about 60% by weight, based on the total weight of all monomers and chain transfer agent(s) from which the copolymer is formed.

### Carboxylic Acid/Anhydride Component Units

The hyperbranched copolymer of the invention also comprises one or more component units corresponding to unsaturated carboxylic acid and/or unsaturated anhydride monomers.

Representative species include mono and dicarboxylic acids, such as acrylic acid, methacrylic acid, crotonic acid, itaconic acid, maleic acid, fumaric acid, angelic acid, glutaconic acid, cinnamic acid, carboxyl cinnamic acid, styrene dicarboxylic acid, and the like. Half-esters of the dicarboxylic acids with alkanols can also be used, as can anhydrides. Maleic anhydride, 4-vinyl-isobenzofuran-1,3-dione and 5-vinyl-isobenzofuran-1,3-dione are exemplary C₃-C₁₂ α,β-ethylenically unsaturated carboxylic anhydrides.

In various good embodiments of the invention a copolymer chain includes units derived from one and only one C₃-C₁₂ α,β-ethylenically unsaturated carboxylic acid or anhydride monomer. In other embodiments a copolymer chain includes units derived respectively from two separate C₃-C₁₂ α,β-ethylenically unsaturated carboxylic acid or anhydride monomers which are present in a copolymer surfactant chain. And in yet other embodiments a copolymer chain includes units derived respectively from three C₃-C₁₂ α,β-ethylenically unsaturated carboxylic acid or anhydride monomers. It is, of course, to be understood that when units corresponding respectively to two or more separate C₃-C₁₂ α,β-ethylenically unsaturated carboxylic acid or anhydride monomers are present in a copolymer chain, each separate monomer can be an acid or an anhydride independently of the other(s).

In certain good embodiments, the one or more unsaturated carboxylic acid or anhydride monomers are present in the polymerization process at a concentration of from about 10% to about 80% by weight, preferably about 15% to about 50% by weight, and more preferably about 20% to about 45% by weight, based on the total weight of all monomers and chain transfer agent(s) from which the copolymer is formed. In another embodiment component units corresponding to acrylic acid are present at a concentration of from about 20% to about 45% by weight, based on the total weight of all monomers and chain transfer agent(s) from which the copolymer is formed.

### Surfactant Component Units

The hyperbranched copolymer of the invention also comprises one or more component units corresponding to a surfactant monomer. As used herein, the expression “surfactant monomer” shall be deemed to mean a compound having a hydrophilic moiety containing an unsaturated bond capable of entering into a polymerization reaction, and a hydrophobic moiety, connected by a bridging moiety comprising—and preferably joined to one another by a bridging moiety consisting essentially of a polymeric moiety with repeating carbonyl groups. The expression encompasses, but is not limited to, species comprising one or more of at least one acrylic ester or methacrylic ester, i.e., a “(meth)acrylic ester,” of an ethoxylated hydrophobic moiety, for instance, alkyl, alkylphenyl, monostyrylphenyl, distyrylphenyl, tristyrylphenyl and the like. The surfactant monomer can have a structure as depicted by the formula:

H₂C═C(X)—C(O)O-E-R (I)

where X is hydrogen or methyl, E is a hydrophilic moiety such as ethoxylate and the like, and R is a hydrophobic moiety such as alkyl, alkylphenyl, monostyrylphenyl, distyrylphenyl or tristyrylphenyl and the like. Representative suitable surfactant monomers include the acrylic or methacrylic acid esters of nonionic surfactant alcohols, such as alkylpolyethyleneoxy (meth)acrylates or alkylphenylpolyethyleneoxy (meth)acrylates, where the alkyl group contains, independently, from 1 to 30 carbon atoms, and the tristyrylphenylpoly(ethyleneoxy) (meth)acrylates. It is to be understood that, as used herein, the term “tristyrylphenyl,” either alone or as a portion of a chemical name and unless otherwise indicated, includes any and all of monostyrylphenyl, distyrylphenyl, tristyrylphenyl, and mixtures of two or more thereof. The alkylpolyethyleneoxy (meth)acrylate or alkylphenylpolyethyleneoxy (meth)acrylate may have an alkyl group which contains, independently, from 1 to 22 carbon atoms or the alkylpolyethyleneoxy (meth)acrylate or alkylphenylpolyethyleneoxy (meth)acrylate may have an alkyl group which contains, independently, from 9 to 22 carbon atoms.

Additional examples of surfactant monomers include one or more of a nonylpoly(ethyleneoxy)acrylate, decylpoly(ethyleneoxy)acrylate, undecylpoly(ethyleneoxy)acrylate, oleylpoly(ethyleneoxy)methacrylate, behenylpoly(ethyleneoxy)methacrylate, tristyrylphenylpoly(ethyleneoxy)methacrylate, or a mixture thereof. Still further examples of surfactant monomers encompass species comprising one or more of behenylpoly(ethyleneoxy)acrylate, behenylpoly(ethyleneoxy)methacrylate, decylpoly(ethyleneoxy)acrylate, decylpoly(ethyleneoxy)methacrylate, tristyrylphenylpoly(ethyleneoxy)acrylate, tristyrylphenylpoly(ethyleneoxy)methacrylate, or a mixture thereof as well as species comprising one or more of behenylpoly(ethyleneoxy)methacrylate, decylpoly(ethyleneoxy)acrylate, tristyrylphenylpoly(ethyleneoxy)acrylate, tristyrylphenylpoly(ethyleneoxy)methacrylate, or a mixture thereof.

Further examples of surfactant monomers are species comprising one or more of a tristyrylphenylpoly(ethyleneoxy)acrylate, tristyrylphenylpoly(ethyleneoxy)methacrylate, tristyrylphenylpoly(ethyleneoxy)acrylate and tristyrylphenylpoly(ethyleneoxy)methacrylate, or a mixture thereof. Also, the surfactant monomer known as Nopol® (described in U.S. Pub. App. No. US20060270563, incorporated by reference herein) may be used.

It will be understood by one of ordinary skill in the art that component units corresponding to one or more types of surfactant monomers can be present. The amount of one or more surfactant monomers is preferably from about 0.01% to about 20% by weight, more preferably be from about 0.03% to about 16% by weight, and especially preferably about 0.5% to about 13% by weight, based on the total weight of all monomers and chain transfer agent(s) from which the copolymer is formed.

In one embodiment, where the surfactant monomer is selected from nonylpoly(ethyleneoxy)acrylate, decylpoly(ethylenoxy)acrylate, undecylpoly(ethyleneoxy)acrylate, oleylpoly(ethyleneoxy)methacrylate, behenylpoly(ethyleneoxy)methacrylate, tristyrylphenylpoly(ethyleneoxy)methacrylate, or a mixture thereof, copolymer is formed from an amount of surfactant monomer(s) is from about 0.5% to about 13% by weight, based on the total weight of all monomers and chain transfer agent(s) from which the copolymer is formed.

In each of the surfactant monomers containing (ethyleneoxy) groups, the number of ethylene oxide units present is preferably from about 4 to about 200, more preferably from about 4 to about 60, and especially preferably from about 10 to about 40.

### Chain Transfer Agent Component Units

One or more chain transfer agents are used to effect “hyperbranching” of the copolymers of the invention. Chain transfer agents useful in preparing hyperbranched copolymers of the invention include linear or branched C₄-C₂₂ alkyl mercaptans (such as n-dodecyl mercaptan and t-dodecyl mercaptan), isopropanol, halogenated compounds, n-butyl mercaptan, n-amyl mercaptan, i-octyl 2-mercaptoproprionate, alkyl thioglycolate, mercaptoproprionic acid and alkyl mercaptoalkanoate. More specifically, when incorporated into a growing branch of the copolymer, chain transfer agents terminate extension of that branch. As discussed later, the use of crosslinking monomer(s) results in hyperbranching where many branches form and grow in length. These branches propagate at the numerous branch points available. This gives rise to an unusually large number of branches. In order to regulate the molecular weight of the hyperbranched copolymer, a chain transfer agent, or combination of multiple agents is utilized to react with the component unit at the end of the branch, to terminate growth of the branches before they increase in size to the length which would otherwise be attained in their absence, thereby providing a ceiling on the molecular weight. Thus, the molecular weight of the hyperbranched copolymer can be regulated by altering the amount of chain transfer agent used in embodiments of the present invention.

In various good embodiments, one or more a chain transfer agents are present in an amount of about 0.02% to about 8% by weight, and more preferably in an amount of about 1% to about 3% by weight, of the total amount of monomers and chain transfer agent(s) from which the hyperbranched copolymer is formed.

### Crosslinking Component Units

Furthermore, the copolymer of the invention also comprises copolymer units corresponding respectively to one or more crosslinking monomers. Incorporation of these units has the effect of contributing to modification of the molecular weight of and promoting enhanced the branching of the copolymers of the invention.

Crosslinking monomers suitable for practice of the invention have multiple, and in any event at least two reactive unsaturated, preferably ethylenically unsaturated, bonds in a single molecule. In certain good embodiments of the invention, the crosslinking monomer(s) used has at least three reactive ethylenically unsaturated bonds in a single molecule. Such compounds are referred to as “multifunctional crosslinking monomers.” Component units corresponding to one or more multifunctional crosslinking monomers are, for example, units corresponding to one and only one multifunctional crosslinking monomer, or alternatively, units corresponding to one or another of multiple different multifunctional crosslinking monomers that all are used in the polymerization reaction, to yield the increased amount of branching sought.

Examples of the foregoing are component units corresponding to multi-functional crosslinking monomers such as trimethylolpropane triacrylate, ethoxylated trimethlolpropane triacrylate, propoxylated trimethylolpropane triacrylate, propoxylated glyceryl triacrylate, pentaerythritol triacrylate, tris (2-hydroxy ethyl) isocyanurate triacrylate, ditrimethylolpropane tetraacrylate, pentaerythritol tetraacrylate, ethoxylated pentaerythritol tetraacrylate, pentaacrylate ester and dipentaerythritol pentaacrylate.

Frequently, unsaturated crosslinking monomer is present in an amount from about 0.5% to about 70%, preferably from about 0.5% to about 10%, more preferably from about 0.5% to about 5% by weight, of the monomers and chain transfer agent(s) from which the copolymer is formed (though those of ordinary skill, equipped with the teachings herein, will be able to determine, as a matter of routine experimentation, instances in which greater or lesser amounts can sometimes suffice without the exercise of inventive skill).

Each component unit corresponding to multifunctional crosslinking monomer in a polymer chain serves as a branch point, from which a branch structure can propagate. As the amount (given above) of multifunctional crosslinking monomer used in the polymerization reactions is increased, and thus the amount of corresponding component units in the copolymer is increased, more branching occurs and the molecular weight of the hyperbranched copolymer is increased. It follows that the amount of branching can be regulated by altering the amount of multifunctional crosslinking monomer used in embodiments of the present invention while, as discussed hereinabove, the average size of the branches is controlled by altering the amount of chain transfer agent.

In an exemplary embodiment, hyperbranched copolymers of the invention are prepared from, and accordingly contain component units corresponding to, the following monomer amounts:

(a) from about 10% to about 90% by weight of at least one monomer selected from the group consisting of acrylic monomers, vinyl monomers and styrenic monomers;

(b) from about 10% to about 80% by weight of at least monomer selected from the group consisting of unsaturated carboxylic acid and anhydride monomers;

(c) from about 0.01% to about 20% by weight of at least one surfactant monomer;

(d) from about 0.02% to about 8% by weight of at least one chain transfer agent;

(e) from about 0.5% to about 70% by weight of at least one ethylenically unsaturated crosslinking monomer.

### Preparation of Copolymers

Hyperbranched copolymers of the invention can be prepared by solution copolymerization of the monomers through free-radical, stable free-radical (e.g., using the well-known compound TEMPO), anionic or cationic polymerization in a solvent, such as an oxygenated solvent, or in a mixture of solvents. The conditions under which such polymerization is conducted are those conventionally utilized, and one of ordinary skill (once in possession of the teachings herein) will be able to determine appropriate conditions as a matter of routine investigation and without undue experimentation.

Examples of oxygenated solvents are glycols including ethylene glycol, propylene glycol, glycerol, diethylene glycol, triethylene glycol, tetraethylene glycol, and other polyethylene glycols of relatively low number average molecular weight, e.g., below about 1,000 Daltons. Cellosolves and cellosolve derivatives, such as cellosolve acetate, can also be used as the oxygenated solvent.

When hyperbranched copolymers of the invention are prepared by emulsion copolymerization, a continuous aqueous phase emulsion using an emulsifier is preferred. This can be done by conventional emulsion polymerization at a pH below about 5.0 using a conventional free-radical producing initiator(s), such as ammonium persulfate, sodium persulfate, potassium persulfate, cumene hydroperoxide, tert-butyl hydroperoxide, benzoyl peroxide, acetyl peroxide, lauroyl peroxide, peracetic acid, perbenzoic acid and/or 2,2-azobisisobutyronitrile. In another embodiment, the amount of initiator used is from about 0.05% to about 3.5%, preferably from about 0.75% to about 3.2% by weight based on total weight of all monomers and chain transfer agent(s) present. Often, the polymerization usually is carried out under a relatively inert atmosphere, such as is provided by nitrogen or argon gas, at a temperature of from about 60° C. to about 90° C. Of course, as will be apparent to one skilled in the art, higher or lower temperatures can be used depending on the type of initiator(s) present. The polymerization can be carried out in a batch-wise or step-wise manner or with continuous addition of monomers in a conventional manner. The surfactant monomer(s) can be fed simultaneously with other monomers, or after a proportion of other monomers has been reacted.

In various good embodiments, at least one anionic, cationic, nonionic or amphoteric emulsifier, or a combination of more than one of the foregoing, is used in the emulsion copolymerization by which the hyperbranched copolymer is prepared. In another embodiment, at least one anionic emulsifier, at least one nonionic emulsifier, or a mixture thereof is used. When more than one emulsifier is present, any additional emulsifier is sometimes known as a co-emulsifier. A wide variety of emulsifiers are available, many being listed in McCutcheon's Emulsifiers & Detergents, North American Ed., Manufacturing Confectioner Pub. Co., Glen Rock, N.J., 1988, pp. 1-217, which is incorporated by reference herein. The emulsifiers can be nonionic, have an anionic charge, have a cationic charge, or have both an anionic and a cationic charge, e.g., an amphoteric emulsifier, where each charge has associated with it a suitable counter ion; numerous examples of each are known in the art. See Lynn, Jr. et al., “Surfactants” in Kirk-Othmer Encyc. of Chem. Technol., 4th Ed., John Wiley & Sons, New York, 1997, Vol. 23, pp. 483-541, which is incorporated by reference herein.

Suitable nonionic emulsifiers are alkylphenol ethoxylates, such as nonylphenol ethoxylate and the like. Suitable anionic emulsifiers include alkali metal alkyl aryl sulfonates, alkali metal alkyl sulfates, the sulfonated alkyl esters, e.g., sodium dodecylbenzene sulfonate, sodium disecondary-butylnaphthalene sulfonate, sodium lauryl sulfate, disodium dodecyldiphenyl ether disulfonate, disodium n-octadecylsulfosuccinamate, sodium dioctylsulfosuccinate, and the like. Suitable cationic emulsifiers include amines, e.g., aliphatic mono-, di- and polyamines derived from fatty and rosin acids, and quaternary ammonium salts, e.g., dialkyldimethyl and alkyltrimethyl ammonium salts, alkylbenzyldimethyl ammonium chlorides, and alkylpyridinium halides.

Suitable amphoteric emulsifiers include but are not limited to imidazoline derivatives, such as disodium lauroampho diacetate, disodium cocoampho diacetate, sodium cocoampho acetate, sodium cocoampho propionate, sodium lauroampho acetate, disodium cocoampho dipropionate, cocoampho dipropionic acid, sodium capryloampho carboxylate, sodium cocoampho hydroxypropyl sulfonate, sodium carpryloampho hydroxypropyl sulfonate, and the like; alkyl betaines, such as lauramidopropyl betaines, coco dimethyl betaine, oleamidopropyl betaine, and the like; sultaines, such as alkylether hydroxypropyl sultaine, cocamidopropyl hydroxyl sultaine, and the like; dihydroxyethyl glycinates, such as dihydroxyethyl tallow glycinate and the like; and aminopropionates, such as sodium laurimino dipropionate and the like.

In various good embodiments, the emulsifier contains a sulfonate, a sulfate, an alkylphenol ethoxylate, or a mixture thereof, the emulsifier is sodium dodecylbenzene sulfonate, sodium disecondary-butylnaphthalene sulfonate, sodium cocoampho hydroxypropyl sulfonate, sodium carpryloampho hydroxypropyl sulfonate, or a mixture thereof, the sulfate emulsifier is sodium lauryl sulfate; or the alkylphenol ethoxylate emulsifier is nonylphenol ethoxylate.

In preparing a hyperbranched copolymer by emulsion polymerization, the amount of emulsifier used is typically from about 0.2% to about 10% by weight based on the total weight of the emulsion. The amount of emulsifier used is preferably from about 0.5% to about 10% and more preferably from about 0.5% to about 4.0%, by weight based on the total weight of the emulsion.

### Additional Products

The inventive embodiments constituting colorant compositions, aqueous polymer dispersions such as tint bases, and water-based coatings such as latex paints, typically comprise (as necessary or advantageous) a range of other components. Thus, the colorant compositions contain not only a hyperbranched copolymer (which can be present as a dispersion of the polymer) but can also contain one or more surfactants and/or dispersants, one or more water-dispersible polymers, one or more low number average molecular weight polymers (such as polyethylene glycol or polypropylene glycol) each with an average molecular weight below about 1000 Daltons, and one or more rheology modifiers, for instance thickeners, especially associative thickeners. In some cases the colorant composition can even comprise a film-forming latex binder component, though the colorant composition embodiments do not contain film-forming latex binder amounts sufficient for the formation of a suitable paint film, and thus do not constitute a tint-base or other aqueous polymer dispersion, or a latex paint or other water-based coating as meant in this disclosure. Similarly, the tint-bases and other dispersions, as wells as the aforementioned coatings (including the latex paint) and resultant film contain not only hyperbranched copolymers, but also contain surfactants and/or dispersants, and optionally one or more water-dispersible polymers, one or more low number average molecular weight polymers (such as polyethylene glycol or polypropylene glycol) each with an average molecular weight below about 1000 Daltons, and one or more rheology modifiers, for instance thickeners, especially associative thickeners and at least one oxygenated solvent (as well as at least one coalescence solvent). (It goes without saying that, the latex paint, paint film, etc. contain a film-forming latex binder component in amount sufficient for the formation of a suitable paint film, it being understood that, the film-forming binder latex in a paint film embodiment can be in the cured “film” state.)

Another embodiment of the present invention relates to a colorant composition comprising water in which at least one pigment is dispersed, and one or more hyperbranched copolymers of the invention. In more specific embodiments of the present invention a colorant composition comprises, in addition to water, at least one pigment, and at least one hyperbranched copolymer, one or more of the following:

(a) an oxygenated solvent,

(b) a low number average molecular weight polymer, such as polyethylene glycol or polypropylene glycol, each with a number average molecular weight below about 1,000 Daltons, as a relatively non-volatile solvent,

(c) a conventional surfactant, such as an anionic, cationic, nonionic, or amphoteric surfactant, or a combination of two or more such surfactants, and

(d) a conventional HASE copolymer.

Suitable oxygenated solvents are, e.g., ethylene glycol, propylene glycol, glycerol, diethylene glycol, triethylene glycol, tetraethylene glycol and other glycols such as listed in the Kirk-Othmer Encyc. of Chem. Technol., 3rd Ed., John Wiley & Sons, New York, 1980, Vol. 13, pp. 933-971 (incorporated by reference herein). Suitable low molecular weight polymer glycols, include polyethylene glycol, polypropylene glycol and the like with a number average molecular weight of less than about 1,000 Daltons. These substances can affect the drying properties of colorant compositions of the invention. At least one of these oxygenated solvents and/or low molecular weight polymer glycols can be present in colorant compositions of the invention, but their use is optional.

In certain embodiments of the invention, a plurality of polymeric surfactants is used. At least one is a hyperbranched copolymer of the invention and at least one is a HASE copolymer known in the art, such as those disclosed in U.S. Pat. No. 4,138,381; No. 4,421,902; No. 4,423,199; No. 4,432,881; No. 4,529,773; No. 4,569,965; No. 4,600,761; No. 4,616,074; No. 4,892,916; and the like, which are incorporated by reference herein.

The hyperbranched copolymers of the invention can also be used in combination with other water-soluble polymers, including but not limited to polycarboxylic acids, copolymers comprising monomers containing a carboxylic acid, water soluble copolymers, cellulose derivatives, salts of polyacrylic acids, salts of copolymers comprising monomers containing an acrylic acid, polyvinylpyrrolidone, and copolymers comprising vinylpyrrolidone monomer. In another embodiment, the water-soluble polymer is a salt of a polyacrylic acid, a salt of a copolymer comprising a monomer containing an acrylic acid, or a mixture thereof. Conventional emulsifiers or surfactants, i.e., anionic, cationic, nonionic, amphoteric surfactants and mixtures thereof, can also be used with the hyperbranched copolymers of the invention. In one embodiment, a conventional surfactant is absent. In another embodiment, the conventional surfactant is at least one anionic surfactant, nonionic surfactant, amphoteric surfactant, or a mixture thereof. In another embodiment, only a small amount of a conventional surfactant(s) is present, i.e., an amount such that the low-shear viscosity of a latex paint or other water-based coating in which a colorant composition according to the invention is incorporated—after addition of the conventional surfactant(s) to that colorant composition—is substantially unchanged compared to the low-shear viscosity of the latex paint or other water-based coating to which the colorant composition (without conventional surfactant(s)) is added.

Another aspect of the present invention relates to a method of making a colorant composition comprising combining hyperbranched copolymer of the invention, optionally a conventional HASE copolymer, water and at least one pigment.

Each colored pigment included in a colorant composition, aqueous polymer dispersion, or water-based coating of the invention can be an organic pigment or an inorganic pigment; such pigments are well-known in the art. Organic pigments include phthalocyanine blue, phthalocyanine green, monoarylide yellow, diarylide yellow, benzimidazolone yellow, heterocyclic yellow, DAN orange, quinacridone magenta, quinacridone violet, organic reds, including metallized azo reds and nonmetallized azo reds, and the like. Exemplary azo reds include lithols, lithol rubine, toluidine red, naphthol red and quinacridone red. Metallized azo reds are salts containing metal cations, such as barium or calcium salts of azo reds, e.g., calcium lithol rubine and barium lithol red. Nonmetallized azo reds are substantially free of metal cations. Inorganic pigments include titanium dioxide white, carbon black, lampblack, black iron oxide, yellow iron oxide, brown iron oxide, red iron oxide, and the like.

Each white pigment, off-white pigment or extender pigment included in a colorant composition, colorant composition, aqueous polymer dispersion, or water-based coating of the invention can comprise a titanium dioxide or off-white pigment, or other suitable white pigment, off-white pigment or extender pigment, for example talc or silica, known in the art.

Since the hyperbranched copolymers of the invention are compatible with conventional surfactants and water-soluble polymers those latter species can be incorporated into a colorant composition of the invention for additional benefit. Generally, hyperbranched copolymers of the invention provide a rheology profile and flow/leveling similar to or equivalent to that of HEURs. Incorporating the hyperbranched copolymer of the present invention into a colorant composition can, desirably, significantly reduce the amount of conventional surfactant(s) used in those colorant compositions or even eliminate the need for a conventional surfactant therein. However, if and when the hyperbranched copolymers of the invention affects the compatibility of the colorant composition with a tint-base or other aqueous polymer dispersion, the rheology profile of the colorant composition, or flow/leveling characteristics and/or the surface tension, a small amount of a conventional surfactant(s) and/or dispersants, and/or a water-soluble polymer(s), e.g., a polymer containing carboxylic groups, can be included, as known to those skilled in the art, to adjust the properties of the colorant composition.

In some embodiments, the hyperbranched copolymers of the invention are multi-functional, e.g., contain multi-hydrophobic heads and/or multi-hydrophilic tails. The hydrophobe(s) present in the hyperbranched copolymers can associate with organic pigments, and the electrolytes from neutralization of carboxylic acid groups can interact with inorganic pigments. Through judicious selection of hydrophobe(s) and/or monomers in the copolymer chain, which is familiar to those in the art and, at most, requires only minimal routine investigation without undue experimentation, the hyperbranched copolymer should be capable of emulsifying both organic and inorganic pigments in another embodiment.

Once in possession of the teachings herein, one of ordinary skill will be able to determine, as a matter of routine testing and without undue experimentation, amounts of hyperbranched copolymer suitably incorporated in colorant compositions to secure the desired surfactant effect. The information, in the Examples hereinafter, confirms same. In various good embodiments of the invention, the amount of hyperbranched copolymer incorporated in the colorant composition is from 0.5 to 16, preferably from 1 to 12, and more preferably from 2 to 8, weight percent based on the total amount of solids in the colorant composition.

Yet another aspect of the invention is a tint base or other aqueous dispersion which comprises water, at least one film-forming polymer and at least one hyperbranched copolymer as aforesaid. It will be understood by those of ordinary skill in the art that the tint base or other aqueous dispersion contains other additives conventionally incorporated therein, including optionally (at least in the case of tint bases) one or more white or other base pigments as well as extender pigments, in customary amount.

The hyperbranched copolymer of the invention is compatible with the full range of film-forming polymers conventionally utilized in the coating field. Examples of film-forming emulsion polymers which are suitable for use in the invention are acrylic, vinyl, polyvinyl acetate, vinyl acrylic, styrenic, and styrenated acrylic polymers, among others. The film-forming polymer varies by the intended application and a person of ordinary skill in the art will be able to determine, as a matter of routine testing and without under experimentation, which film-forming polymer to use for a particular application. When combined with film-forming polymer(s) in a tint base, or other aqueous dispersion, the hyperbranched copolymer causes the tint base to exhibit desired low or middle shear viscosity (Kreb units—unit amounts depending upon the desired characteristics of a particular formulation) with improved flow and leveling.

Once in possession of the teachings herein, those of ordinary skill in the art will be able to determine, as a matter of routine testing and without under experimentation, amounts of hyperbranched copolymer which are effective to confer appropriate low or middle shear viscosity with improved flow and leveling on the tint base or other aqueous dispersion. In certain good embodiments of the invention, the amount of hyperbranched copolymer incorporated in the tint base or other aqueous dispersion is from 0.1 to 25, preferably from 1 to 20, and more preferably from 2 to 15 weight percent based on the total amount of polymer solids in the tint base or other aqueous dispersion.

Another embodiment of the present invention relates to a paint or other water-based coating, comprising a tint-base and a colorant composition of the invention, both as hereinbefore described. Again, the hyperbranched copolymer of the invention is compatible with a wide range of film-forming additives conventionally incorporated in latex paints, as specified hereinbefore. When so incorporated, the hyperbranched copolymers of the invention cause the water-based paint or other water-based coating to exhibit appropriate low or middle shear viscosity with improved flow and leveling.

The ordinarily skilled worker, equipped with the teachings herein, will be able to determine, as a matter of routine investigation, and without undue experimentation, amounts of hyperbranched copolymer which are effective to confer appropriate low or middle shear viscosity with improved flow and leveling on the paint or other coating. In certain good embodiments of the invention, the amount of hyperbranched copolymer incorporated in the paint or other coating is from 0.1 to 20, preferably from 1 to 15 and more preferably from 2 to 10, weight percent based on the total amount of polymer solids in the paint or other coating.

It is noteworthy that the hyperbranched copolymers of the invention can also interact with latex particles and/or with associative rheology modifiers of a tint-base or other aqueous dispersion, as well as of a latex paint or other water-based coating. Because, in various embodiments, the hyperbranched copolymers of the invention are multi-functional and their copolymer chains are sufficiently long, they can associate, on multiple sites of the copolymer chain, with surfaces of film-forming (i.e., latex) particles and with “bridging micelles” of associative thickeners. Without wishing to be bound by theory, it is thought that the presence of the hyperbranched copolymers of the invention does not substantially change the low-shear viscosity, e.g., Stormer viscosity, and instead substantially preserves the network structure of latex paints and other water-based coatings. That is, colorant compositions of the present invention are such that, when incorporated in such paint or other coating formed of a mixture comprising such a composition and a tint-base or other aqueous polymer dispersion, they do not result in a substantial change of the Stormer low-shear viscosity of said paint/coating compared with the Stormer low-shear viscosity of the tint-base/aqueous dispersion. This is advantageous when a hyperbranched copolymer of the invention is included in the aforementioned colorant compositions, which in turn are incorporated in such paint or other coating formed of a mixture comprising such composition and such tint-base or other dispersion. Introducing the hyperbranched copolymer of the invention by incorporating it in colorant compositions yields the desired mitigation of substantial change in the Stormer low-shear viscosity of the paint or other coating compared with the Stormer low-shear viscosity of the tint-base or other dispersion, while at the same time preserving the efficacy of the hyperbranched copolymer through sequestering it from exposure to reactive substances in the tint base or other dispersion until mixing at the desired time.

In further good embodiments, the Stormer low-shear viscosity of a paint or other coating tinted with a colorant composition of the invention is within about +20%, preferably +15%, of the Stormer low-shear viscosity of the tint-base or other dispersion from which the paint or other coating was formed. An even more preferred embodiment is one in which the low-shear viscosity of a paint or other coating tinted with a colorant composition of the invention is within about ±10%, especially ±5%, and particularly ±3%, of the low-shear viscosity of the tint-base or other dispersion from which the paint or other coating was formed.

Another advantage of the hyperbranched copolymers of the invention is the ease with which the rheology of a colorant composition of the invention can be controlled without substantially impacting the rheology profile, e.g., the ICI viscosity, of a tint-base. Therefore, the excellent flow and leveling properties that HEURs impart to latex paints and other water-based coatings containing such HEURS should not be affected. In addition, the hyperbranched modified water soluble copolymers of the invention have minimal impact on gloss.

In colorant compositions including a hyperbranched copolymer of the invention as a colored pigment dispersant, the colorant composition should have little influence on the high-shear viscosity, resulting in a reduced need or elimination of the need for viscosity adjusters such as silicates. Thus, in various good embodiments, the high-shear viscosity of a latex paint or other water-based coating tinted with a colorant composition of the invention is within about 10% of the high-shear viscosity of the tint-base or other aqueous polymer dispersion from which the paint was formed.

### EXAMPLES

As noted hereinbefore, the hyperbranched copolymers of the invention impart advantageous performance to, e.g., water-based coatings, such as latex paint, formed of colorant compositions in which at least one pigment is dispersed by a hyperbranched copolymer of the invention.

The following examples further illustrate certain embodiments of the present invention. These examples are provided solely for illustrative purposes and in no way limit the scope of the present invention. It is noted that, because of rounding, the sum of the amounts of each ingredient present may not equal the total in every case.

### Example 1

### Preparation of a Copolymer with Hyperbranched Structure

The emulsion polymerization reaction is carried out in a four-neck flask of about 1 U.S. gallon capacity under nitrogen purge. The reaction flask is equipped with a condenser, a thermometer, an agitator and a feeding pump. The flask is immersed in a temperature controlled water bath maintained at a constant temperature within about ±0.1° C. of the set point. Table 1 shows the ingredients used for preparing the hyperbranched copolymer of this Example.

Deionized water and the surfactant ammonium nonylphenyl ether persulfate (Alipal® CO 436, obtained from Rhodia Inc. in Cranbury, N.J.) were charged into the reaction flask and its contents were heated to 80° C. At 80° C., 6% by weight of the Monomer Emulsion, containing surfactant CO 436 and ABEX 2020 a mixed surfactant from Rhodia Inc., was charged into the reaction flask and held for 10 minutes. Thereafter, Initiator Solution 1 was charged into the reaction flask and held for 15 minutes. Initiator Solution 2 and the remaining Monomer Emulsion were then fed into the reaction flask over a period of from about 3 to about 4.5 hours. After feeding was complete, the feeding line was rinsed or flushed with water; the rinse water also entered the reaction flask. The temperature of the reaction flask was maintained at 80-85° C. for one hour after which it was cooled to about 25° C. and the hyperbranched copolymer product, in the form of a latex or emulsion, was recovered.

The copolymer of Example 1 comprised 31.3 parts by weight surfactant monomer which is tristyrylphenylpoly(ethyleneoxy)methacrylate (60% active), 3.13 parts by weight multi-functional crosslinking monomer which is ethoxylated (20 EO units) trimethylolpropane Triacrylate with three reactive ethylenically unsaturated (double) bonds and 3 parts by weight chain transfer agent that is i-octyl 2-mercaptopropionate.

TABLE 1
Ingredients for Preparation of Hyperbranched Copolymer

| Component | Parts (by weight) |
|---|---|
| Initial Charge in Reactor | |
| Deionized water | 740 |
| Ammonium nonylphenyl ether persulfate (Alipal ® | 0.8 |
| CO 436) | |
| Monomer Emulsion | |
| Deionized water | 210 |
| Ammonium nonylphenyl ether persulfate (Alipal ® | 6 |
| CO 436) | |
| ABEX 2020 (mixed surfactant from Rhodia) | 17 |
| Methacrylic acid | 145 |
| Vinyl acetate | 145 |
| Butyl acrylate | 145 |
| Tristyrylphenylpoly(ethyleneoxy) methacrylate (60% | 31.3 |
| active ingredient) | |
| Ethoxylated (20 Eos) trimethylolpropane Triacrylate | 3.13 |
| (Sartomer, SR-415) | |
| i-Octyl 2-mercaptopropionate | 3 |
| Initiator Solution 1 | |
| Ammonium persulfate | 0.5 |
| Deionized water | 20 |
| Initiator Solution 2 | |
| Ammonium persulfate | 0.6 |
| Deionized water | 30 |
| Ammonium nonylphenyl ether persulfate (Alipal ® | 4 |
| CO436) | |
| Abex 2020 (mixed surfactant from Rhodia) | 6 |
| Rinse | |
| Deionized water | 10.0 |
| Total | 1517 |

### Example 2

### Preparation of a Second Copolymer with Hyperbranched Structure

A second hyperbranched copolymer was prepared according to the procedure of Example 1 except that 5 parts by weight of ethoxylated (20 EO units) trimethylolpropane triacrylate and 5 parts by weight of i-octyl 2-mercaptopropionate were used.

### Example 3

### Preparation of a Third Copolymer with Hyperbranched Structure

A third hyperbranched copolymer was prepared according to the procedure of Example 1 with the following modifications: the 3.13 parts by weight of ethoxylated (20 EO units) trimethylolpropane triacrylate in Example 1 was replaced with 5 parts by weight of dipentaerythritol pentaacrylate which has five reactive ethylenically unsaturated (carbon-carbon double) bonds (Sartomer, SR399LV). Additionally, 2 parts by weight of i-octyl 2-mercaptopropionate were used.

### Example 4

### Preparation of a Fourth Copolymer with Hyperbranched Structure

A fourth hyperbranched copolymer was prepared according to the procedure of Example 1 with the following modifications: 54 parts by weight tristyrylphenylpoly(ethyleneoxy)methacrylate (60% active), 8 parts by weight multi-functional crosslinking monomer which is ethoxylated (4 EO units) pentaerythritol tetraacrylate (Sartomer SR494) and has four reactive ethylenically unsaturated (double) bonds, and 10 parts by weight i-octyl 2-mercaptopropionate were used.

### Example 5

### Comparative Example of Linear Copolymer

For comparison, a linear copolymer was prepared using the same procedure as in Example 1, but using the ingredients listed in Table 2 and with no multi-functional crosslinking monomer or chain transfer agent. The polymer thus formed has a linear chain structure.

TABLE 2
Ingredients for Preparation of Linear Copolymer

| Component | Parts (by weight) |
|---|---|
| Initial Charge in Reactor | |
| Deionized water | 740 |
| Ammonium nonylphenyl ether persulfate (CO 436) | 0.8 |
| Monomer Emulsion | |
| Deionized water | 210 |
| Ammonium nonylphenyl ether persulfate | 6 |
| ABEX 2020 | 17 |
| Methacrylic acid | 145 |
| Vinyl acetate | 145 |
| Ethyl methacrylate | 145 |
| Tristyrylphenylpoly(ethyleneoxy) methacrylate (60% | 15.4 |
| active) | |
| Initiator Solution 1 | |
| Ammonium persulfate | 0.5 |
| Deionized water | 20 |
| Initiator Solution 2 | |
| Ammonium persulfate | 0.6 |
| Deionized water | 30 |
| Ammonium nonylphenyl ether persulfate | 4 |
| ABEX 2020 | 6 |
| Rinse | |
| Deionized water | 10 |
| Total | 1495 |

### Example 6

### Flow/leveling Characteristics of Copolymers

The hyperbranched copolymers were mixed with an acrylic copolymer latex in a ½ pint paint can. The acrylic copolymer latex is made from methyl acrylate and 2-ethylehexyl acrylate at a 40% solids content. The pH of each of the mixtures was adjusted to between 8.5-9.0. Tests 1 to 4 are directed to different four hyperbranched copolymers of the invention. Test 5 is directed to a linear polymer for comparison. Also included as Test 6 is a commercial hydrophobically modified alkali soluble polymer, Acrysol TT-935® available from Rohm & Haas.

TABLE 3
Evaluation of Flow/leveling Characteristics

| Test | Test 1 | Test 2 | Test 3 | Test 4 | Test 5 | Test 6 |
|---|---|---|---|---|---|---|
| Parts by weight Acrylic Latex | 200 | 200 | 200 | 200 | 200 | 200 |
| Polymer (49% solids) | | | | | | |
| Parts by weight hyper | 5.2 | 8.2 | 2.0 | 2.63 | 4.8 | 1 |
| branched polymer | | | | | | |
| KU | 104.6 | 98.4 | 93.7 | 93 | 103 | 83.7 |
| Flow/Leveling Rating | 6 | 7 | 7 | 6 | 1 | 4 |

The flow/leveling of each of the samples was rated on a scale of from 1 to 10 with 10 being the best flow/level characteristics. The flow/level characteristics were determined from draw-downs according to ASTM Standard D406299, “Standard Test Method for Leveling of Paints by Draw-Down Method.” A Leneta Leveling Test Blade (LTB-2) and Leneta Draw-Down Charts (Form 18B), each obtained from the Leneta Company (Mahwah, N.J.), were used for these tests. The drawdowns were evaluated visually and assigned a rating of from 1 to 10, as specified in ASTM D4062

As shown by a comparison of Tests 1-4 with Test 5, acrylic latex polymer thickened with hyperbranched copolymers of Examples 1-4 have much improved flow/leveling characteristics vis-à-vis that with the conventional copolymers of Example 5. Moreover, as demonstrated by a comparison of Tests 1-4 with Test 5, acrylic latex polymer combined with the copolymers of examples 1-4 exhibited superior flow/leveling performance in comparison with such latex polymer combined with the commercial hydrophobically modified alkali soluble polymer of Test 6, Acrysol TT-935, even at lower middle shear viscosity (83 Kreb Units).

### Example 7

### Latex Paints Using Copolymers as Rheology Additives

Example 7 relates to comparison of a paint composition containing the hyperbranched copolymer of Example 2 (Test A) and the control polymer of Example 5 (Test B). The paint composition, processing, and order of component addition for each of Tests A and B are shown in Table 4.

TABLE 4
Ingredients of Latex Paints

| | A | B |
|---|---|---|
| Grind | | |
| Add under agitation at 500 RPM | | |
| WATER | 75 g | 75 g |
| PROPYLENE GLYCOL | 20 | 20 |
| NUOSEPT 95 (preservative) | 1.5 | 1.5 |
| TAMOL 731A (dispersant) | 9.2 | 9.2 |
| TRONOX CR-826 (TiO2) | 280 | 280 |
| DREWPLUS L 475 FOAM (deformer) | 1 | 1 |

Increase agitation to 2000 RPM and grind for 10 minute

| | | |
|---|---|---|
| Let-Down | | |
| Set agitation to 500 RPM, add following ingredients | | |
| TRITON X-100 (surfactant) | 4.45 | 4.45 |
| TEXANOL (Eastman solvent) | 12 | 12 |
| Acrylic latex (copolymer of methyl methacrylate and | 490 | 490 |
| butyl acrylate, 51% solids) | | |
| AMMONIA 26 BE | 3 | 3 |
| WATER | 141 | 161 |
| Polymer of Example 2 | 60 | 0 |
| Polymer of Example 5 | 0 | 20 |
| DREWPLUS L 475 FOAM | 7.5 | 7.5 |

Increase agitation speed to 1000 RPM and mixing for 20 minutes

Flow/leveling characteristics of the paints were evaluated in the same manner as in Example 6. The paints of Tests A and B were found to have a flow/leveling rating of 9 and 4, respectively. Thus, the paint A, containing the hyperbranched copolymer of Example 2 exhibited substantially improved flow and leveling over the paint containing the linear polymer of Example 5.

### Example 8

### Use of Hyperbranched Copolymer as a Dispersant and Rheology Control Agent for Color Pigment Dispersion

A colorant composition comprising a iron oxide yellow pigment and a hyperbranched copolymer of the invention was prepared. The hyperbranched copolymer of Example 3 was incorporated in the form produced by Example 3. Table 5 shows the ingredients used in the iron oxide yellow colorant composition.

The colorant composition was prepared as follows: To a 1 L stainless steel beaker, equipped with a stirrer that stirred under slow agitation at about 500 rpm, was added in the following order: water, emulsion polymer from Example 3 and ammonium hydroxide solution. When the solution became clear, anionic surfactant solution (BYK 190), polyethylene glycol 400, L-475 defoamer and NUOSEPT 95 preservative were added and mixing continued at about 500 rpm for 10 minutes. The mixing speed was increased to about 1,000 rpm and then the powdered pigment iron oxide yellow was added. After mixing for 10 minutes, nonionic surfactant (Triton® X-100) and anionic surfactant (Alipal® CO 436) were added. After addition of the ingredients were complete, the mixing rate was increased to about 2,500 rpm and mixing continued for about 45 minutes at that speed until the mixture appeared to be a homogenous dispersion.

TABLE 5
Iron Oxide Yellow Pigment Concentrate Composition

| Component | Parts by weight |
|---|---|
| Water | 35.93 |
| Ammonium hydroxide (29.4% aqueous | 1.96 |
| solution) | |
| Polymer of Example 3 | 3.60 |
| Anionic surfactant solution (BYK 190, 40% | 2.94 |
| solids aqueous solution) | |
| Polyethylene glycol 400 | 4.89 |
| Defoamer (L475) | 0.59 |
| Preservative (NUOSEPT 95) | 0.29 |
| Yellow iron oxide | 48.46 |
| Nonionic surfactant (Triton X-100) | 0.45 |
| Anionic surfactant (Alipal CO 436) | 0.90 |
| Total | 100 |

### Example 9

### Acrylic Latex Paints Tinted with Colorant Composition

The latex base paint used for evaluation was Benjamin Moore Aura Interior Matte Finish Deep Base 5223X, available from Benjamin Moore. In a one gallon can which contained 112 ounces of untinted latex base paint, 18 ounces of the colorant composition of Example 8 were added. The tinted paint was mixed with a mechanical paint shaker for 6 minutes.

Control colorant compositions for comparison purposes were Benjamin Moore Water Borne Colorants Oxide Yellow and Benjamin Moore Universal Colorant Oxide Yellow, both available from Benjamin Moore.

The latex base paint had a Stormer viscosity, measured at 25° C., of 1110.8 Krebs Units (“KU”). The latex base paint had an ICI viscosity, measured at 25° C., of 1.61 poise. The ICI viscosity was determined according to ASTM Standard D4287-00, “Standard Test Method for High-Shear Viscosity Using a Cone/Plate Viscometer,” using an ICI Cone/Plate Digital Viscometer model CAP 1000 (obtained from BYK-Gardner USA).

The Stormer viscosity, ICI viscosity and flow/leveling of each tinted paint were measured at 25° C. by the same methods described as for the latex base paint. The results are shown in Table 6.

TABLE 6
Viscosity and Flow/leveling

| Paint Tinted with | | Change in | | Change | Flow/ |
|---|---|---|---|---|---|
| Colorant Composition | KU | KU | ICI | in ICI | Leveling |
| Untinted | 110.8 | — | 1.64 | — | 10 |
| (base paint) | | | | | |
| Example 8 | 109.9 | −0.9 | 1.59 | −0.05 | 10 |
| BenMoore Water Borne | 105.9 | −4.9 | 1.50 | −0.14 | 10 |
| Oxide Yellow | | | | | |
| BenMoore Universal | 77.6 | −33.2 | 1.18 | −0.46 | 10 |
| Colorant Oxide Yellow | | | | | |

As shown above, the latex paint specimen formulated with a colorant composition containing a hyperbranched copolymer (Example 8) in accordance with the invention exhibited very little viscosity change (−0.9). This is in contrast to the viscosity change exhibited by the latex paint specimen formulated with a conventional colorant composition (BenMoore Universal Colorant Oxide Yellow), which change was quite substantial (−33.2). Furthermore—even in comparison with the latex paint specimen formulated using a colorant composition representative of the technology to which U.S. application Ser. Nos. 10/728,599 and 11/319,840 are directed, (BenMoore Oxide Yellow)—the latex paint specimen formed (Example 8 hyperbranched copolymer) was substantially improved, i.e. −0.9 as opposed to −4.9. This is an appreciable achievement as the viscosity of −4.9 is in and of itself a material improvement over the result with conventional technology, i.e., −33.2.

Unless otherwise noted, all percent and parts values given herein are by weight, i.e., weight percent (wt. %) and parts by weight.

While it is apparent that the invention herein disclosed is well calculated to fulfill the objects above stated, it will be appreciated that numerous modifications and embodiments may be devised by those skilled in the art. It is intended that the appended claims cover all such modifications and embodiments as fall within the true spirit and scope of the present invention.

What is claimed is:

1. A copolymer which is capable of functioning as a surfactant and rheology modifier, and which comprises:
(a) component units derived from one or more members of the group consisting of acrylic monomers, vinyl monomers and styrenic monomers;
(b) component units derived from one or more members of the group consisting of carboxylic acid monomers and anhydride monomers, each of which has an unsaturated bond capable of entering into a polymerization reaction;
(c) one or more component units corresponding to a surfactant monomer;
(d) component units corresponding to one or more chain transfer agents; and
(e) component units corresponding to one or more crosslinking monomers, each of which crosslinking monomers has at least three unsaturated bonds capable of entering into a polymerization reaction.

2. The copolymer as defined in claim 1, wherein the copolymer has a molecular weight of about 1,200 Daltons to about 500,000 Daltons.

3. The copolymer as defined in claim 2, wherein the copolymer has a molecular weight of about 10,000 Daltons to about 200,000 Daltons.

4. The copolymer as defined in claim 3, wherein the copolymer has a molecular weight of about 10,000 Daltons to about 100,000 Daltons.

5. The copolymer as defined in claim 1, which is formed by a polymerization reaction wherein the monomers present for reaction include said one or more members selected from the group consisting of acrylic monomers, vinyl monomers or styrenic, and said one or more members constitute from about 10% to about 90% by weight of said monomers and chain transfer agent(s).

6. The copolymer as defined in claim 1, which is formed by a polymerization reaction wherein the monomers present for reaction include said one or more members selected from the group consisting of unsaturated carboxylic acid monomers and anhydride monomers, and said one or more members constitute from about 10% to about 80% by weight of said monomers and chain transfer agent(s).

7. The copolymer as defined in claim 1, which is formed by a polymerization reaction wherein the monomers present for reaction include said surfactant monomer, and said surfactant monomer constitutes from about 0.01% to about 20% by weight of said monomers and chain transfer agent(s).

8. The copolymer as defined in claim 1, which is formed by a polymerization reaction wherein the monomers and chain transfer agent(s) present for reaction include said chain transfer agent(s), and said chain transfer agent(s) constitutes about 0.02% to about 8% by weight of said monomers and chain transfer agent(s).

9. The copolymer as defined in claim 1, which is formed by a polymerization reaction wherein the monomers present for reaction include said crosslinking monomer, and said crosslinking monomer constitutes from about 0.5% to about 70% by weight of said monomers and chain transfer agent(s).

10. The copolymer as defined in claim 9, wherein the crosslinking monomer present for reaction comprises from about 0.5% to about 10% by weight of said monomers and chain transfer agent(s).

11. The copolymer as defined in claim 1, which is soluble in an aqueous medium.

12. The copolymer as defined in claim 11, which is soluble in an aqueous medium of pH about 6.0 or greater.

13. The copolymer as defined in claim 1 which comprises:
(a) component units corresponding to at least one of said acrylic monomers and component units corresponding to a vinyl monomers;
(b) component units corresponding to at least one of said vinyl monomers and component units corresponding to a styrenic monomers;
(c) component units corresponding to at least one of said styrenic monomers and component units corresponding to an acrylic monomers; or
(d) component units corresponding to at least one of said acrylic monomers, component units corresponding to a vinyl monomers, and component units corresponding to a styrenic monomers.

14. The copolymer as defined in claim 1 which comprises:
(a) component units corresponding to at least one of said carboxylic acid monomers and component units corresponding to at least one of said anhydride monomers.

15. The copolymer as defined in claim 1 which comprises:
(a) component units corresponding to a first surfactant monomer, and
(b) component units corresponding to a second and different surfactant monomer.

16. The copolymer as defined in claim 1 which comprises:
(a) component units corresponding to a first chain transfer agent, and
(b) component units corresponding to a second and different chain transfer agent.

17. The copolymer as defined in claim 1 which comprises:
(a) component units corresponding to a first crosslinking monomer, and
(b) component units corresponding to a second and different crosslinking monomer.

18. A method of making the copolymer defined in claim 1, which comprises subjecting the monomers to be polymerized to conditions capable of effecting said polymerization.

19. A colorant composition comprising:
water;
one or more pigments; and
a hyperbranched copolymer which is capable of functioning as a surfactant and/or rheology modifier, and which comprises:
(a) component units derived from one or more members of the group consisting of acrylic monomers, vinyl monomers and styrenic monomers;
(b) component units derived from one or more members of the group consisting of carboxylic acid monomers and anhydride monomers, each of which has an unsaturated bond capable of entering into a polymerization reaction;
(c) one or more component units corresponding to a surfactant monomer;
(d) component units corresponding to one or more chain transfer agents; and
(e) component units corresponding to one or more crosslinking monomers, each of which crosslinking monomers has at least three unsaturated bonds capable of entering into a polymerization reaction.

20. A method of making the colorant composition defined in claim 19, which comprises combining said water, one or more pigments, and said hyperbranched copolymer.

21. An aqueous polymer dispersion comprising:
water;
a film-forming polymer; and
a hyperbranched copolymer which is capable of functioning as a surfactant and/or rheology modifier, and which comprises:
(a) component units derived from one or more members of the group consisting of acrylic monomers, vinyl monomers and styrenic monomers;
(b) component units derived from one or more members of the group consisting of carboxylic acid monomers and anhydride monomers, each of which has an unsaturated bond capable of entering into a polymerization reaction;
(c) one or more component units corresponding to a surfactant monomer;
(d) component units corresponding to one or more chain transfer agents; and
(e) component units corresponding to one or more crosslinking monomers, each of which crosslinking monomers has at least three unsaturated bonds capable of entering into a polymerization reaction.

22. A dispersion as defined in claim 21, which is a tint-base.

23. A dispersion as defined in claim 22 which comprises one or more substances selected from the group consisting of white pigments, off-white pigments, and extender pigments.

24. A method of making the dispersion defined in claim 21, which comprises combining said water, said film-forming polymer, and said hyperbranched copolymer.

25. A water-based coating comprising:
water;
a film-forming polymer;
a white pigment, off-white pigment or extender pigment;
one or more additional color pigments; and
a hyperbranched copolymer which is capable of functioning as a surfactant and/or rheology modifier, and which comprises:
(a) component units derived from one or more members of the group consisting of acrylic monomers, vinyl monomers and styrenic monomers;
(b) component units derived from one or more members of the group consisting of carboxylic acid monomers and anhydride monomers, each of which has an unsaturated bond capable of entering into a polymerization reaction;
(c) one or more component units corresponding to a surfactant monomer;
(d) component units corresponding to one or more chain transfer agents; and
(e) component units corresponding to one or more crosslinking monomers, each of which crosslinking monomers has at least three unsaturated bonds capable of entering into a polymerization reaction.

26. A coating as defined in claim 25, which is a latex paint.

27. A method of making the coating defined in claim 25, which comprises combining said water, said film-forming polymer, said pigments, and said hyperbranched copolymer.
